(19) United States
(12) Patent Application Publication
(10) Pub. No.: US 2019/0205142 A1
(43) Pub. Date: Jul. 4, 2019

(54) SYSTEMS AND METHODS FOR SECURE PROCESSOR

(71) Applicant: Vathys, Inc., Portland, OR (US)

(72) Inventor: Tapabrata GHOSH, Portland, OR (US)

(21) Appl. No.: 16/240,004

(22) Filed: Jan. 4, 2019

Related U.S. Application Data
(60) Provisional application No. 62/613,480, filed on Jan. 4, 2018.

(51) Int. Cl. G06F 9/38; G06F 9/54

(52) U.S. Cl. CPC G06F 9/3844; G06F 9/542

(57) ABSTRACT

Non-architectural effects (e.g., cache presence) of speculative execution can be exploited for malicious purposes. Spectre and Meltdown bugs in particular can infect processors utilizing speculation. Disclosed are processors and methods of configuring processors to minimize or eliminate such side-channel attacks. Disclosed methods and devices do not require modification to instruction set architecture (ISA), enable a processor to perform speculation in a safe manner while maintaining high performance, have low computational overhead load and low power consumption.

### CROSS-REFERENCE TO RELATED APPLICATIONS

This application claims the benefit of priority of U.S. Provisional Application No. 62/613,480 filed on Jan. 4, 2018 entitled “Secure Processor Obviating Speculative Side Channel Attacks,” content of which is incorporated herein by reference in its entirety and should be considered a part of this specification.

### BACKGROUND

### Field of the Invention

This invention relates generally to the field of microprocessors and more particularly to microprocessors that employ speculation to improve performance.

### Description of the Related Art

Microprocessors employing speculation to improve performance exist. For example, such microprocessors can utilize a variety of techniques to execute instructions before they are needed. Many existing microprocessors employing speculation are recently discovered to be vulnerable to side-channel attacks. These attacks exploit vulnerabilities of a computer system due to design and implementation and not vulnerabilities due to algorithm or software running on the computer system. Two examples of side-channel attacks impacting processors that perform speculation are Meltdown and Spectre bugs. Additionally, existing solutions to address these vulnerabilities sometimes require modification of the instruction set architecture (ISA), which may be undesirable or impractical. On the other hand, speculative execution has made modern microprocessors more efficient. Consequently, there is a need for improved microprocessors which can perform speculation, while eliminating or minimizing side-channel attacks.

### SUMMARY

In one aspect of the invention, a method of speculation in a microprocessor is disclosed. The method includes deciding whether to perform speculation; issuing and executing a speculation event; generating speculative data, wherein speculative data comprises instructions and/or data based on the speculation event; receiving and executing non-speculative instructions; generating non-speculative data based on non-speculative instructions; distinguishing between the speculative and non-speculative data and their respective underlying effects; assigning one or more operations to the speculative data and/or instructions; and performing the one or more assigned operations on the speculative data and/or instructions.

In some embodiments, the method further comprises: determining whether the speculation event is valid; committing the speculation event and the speculative data if the speculation event is valid; and removing architectural and non-architectural effects of the speculation event if the speculation event is invalid.

In another embodiment, removing non-architectural effects comprises flushing a region of a cache.

In one embodiment, the assigned one or more operations comprise one or more of marking the speculative data and censoring the marked speculative data until the data is committed or is overwritten.

In some embodiments, the method further comprises storing information on the speculation event and resulting speculative data.

In another embodiment, the method further comprises issuing and executing a plurality of speculation events and storing information further comprises storing information mapping speculation events to their respective speculative data.

In one embodiment, storing information comprises storing bit per word, or a bitmask comprising a number of bits at least equivalent to number of words where speculative data is held.

In some embodiments, the method further comprises loading a program instruction and performing at least one of the one or more assigned operations if the program instruction relies on the speculative data.

In another embodiment, a processor is configured to perform the methods disclosed above.

In another aspect of the invention a processor optimized for performing speculation is disclosed. The processor includes: a processor core configured to issue and execute instructions generating speculative and non-speculative data; a memory configured to store information to distinguish between speculative and non-speculative data; a decision circuit configured to perform one or more operations on the speculative data.

In one embodiment, the processor further includes caches, buffers and registers configured to track speculative data.

In another embodiment, the one or more operations include one or more of marking, censoring, isolating and/or removing the speculative data.

In one embodiment, the stored information further comprises a mapping of speculative data to a speculative instruction.

In some embodiments, the memory configured to store information comprises a lookaside buffer.

In another embodiment, the decision circuit is further configured to perform at least one of the one or more operations when an operational request such as load/store is cast upon a speculative data.

In some embodiments, the processor further includes an overflow memory configured to receive and store overflow speculative data.

In one embodiment, the decision circuit is configured to remove non-architectural effects of the speculative data when the speculative data is determined to be invalid.

In some embodiments, the processor further includes a second memory where speculative data is stored and the memory configured to store information is further configured to store memory addresses in the second memory where speculative data is stored and removing non-architectural effects includes removing speculative data from the second memory.

In another embodiment, the second memory includes a cache and/or buffer of the processor.

In some embodiments, the processor core is configured to decide whether or not to perform speculation.

### BRIEF DESCRIPTION OF THE DRAWINGS

These drawings and the associated description herein are provided to illustrate specific embodiments of the invention and are not intended to be limiting.

FIG. 1 illustrates a diagram of a portion of a microprocessor executing speculative instructions.

FIG. 2 illustrates another diagram of a portion of a microprocessor capable of executing speculative instructions.

FIG. 3a illustrates a flow chart of a process of speculation.

FIG. 3b illustrates a flow chart of a process which a processor can employ to minimize or eliminate side-channel attacks.

FIG. 3c illustrates a flow chart of another process which a processor can employ to minimize or eliminate side-channel attacks.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

### Definitions

“Speculative,” “speculatively” and/or “speculation” can refer to a computer system (e.g., a microprocessor or cache system) performing an action or deriving a variable before the action or variable are commanded or requested by the program being executed on the computer system. For example, when branch prediction speculation is used, a variable may be loaded from memory in speculation that a branch will be executed. Similarly, if a variable with an address as some function of a speculative or non-speculative value is loaded before it is commanded, such a variable would be classified as “speculative.” Another example of a speculative action is when a non-speculative action depends on a speculative value (e.g., a load instruction commanding loading of data from a memory address holding a speculated value is considered a speculative action).

A computer system can utilize various speculation techniques such as branch prediction, run-ahead mode, out-of-order execution, and speculative multithreading.

“Data,” “value” and their respective plural forms can refer to program data, program value, and/or program instructions. Data and value as used in the description herein are not restricted to the terminology of “data” as used and referred to in the Von Neumann architecture terminology.

“Architectural state” of a computer system refers to the content of memory locations of a central processing unit (CPU) which holds the state of a program and/or a process being executed by the computer system. Typically, CPU registers are tasked with holding the program state, but architectural state is not limited to only CPU registers.

“Architectural effects” refer to program instructions, commands, values, data and/or actions of a computer system affecting the program state.

“Non-architectural effects” refer to changes due to program instructions, commands, values, data and/or actions of a computer system that affect the computer system in ways other than the program state. Non-architectural effects can include changes to physical state, memory hierarchy as well as changes to program instructions, values, and data. Cache loading, reorder buffer (ROB), reorder registers, load store queues (LSQs) are examples of actions leading to non-architectural effects in the computer system.

Existing microprocessors are sometimes vulnerable to side-channel attacks, such as Spectre and Meltdown bugs, because they do not take into account the non-architectural side effects of speculative execution (e.g., the presence of speculative data in cache). Furthermore, conventional processors do not distinguish between or track speculative data versus non-speculative data for the purposes of timely cleanup. In some cases, existing processors load speculative data and do not distinguish between speculative and non-speculative data and subsequently take no action when the previously loaded speculative data is found to be invalid. In some cases, existing microprocessors and/or caches clean up architectural states from invalid speculative data, but leave non-architectural effects of the invalid speculative data (e.g., caches holding that data) untouched. Side-channel attacks can occur exploiting such vulnerabilities.

Proposed methods and devices can mark, track and otherwise distinguish speculative data in a microprocessor and subject such data to one or more assigned operations designed to minimize or eliminate side-channel attacks. Furthermore, a microprocessor or cache designed according to described embodiments can remove both architectural and non-architectural effects when speculative data is determined to be invalid.

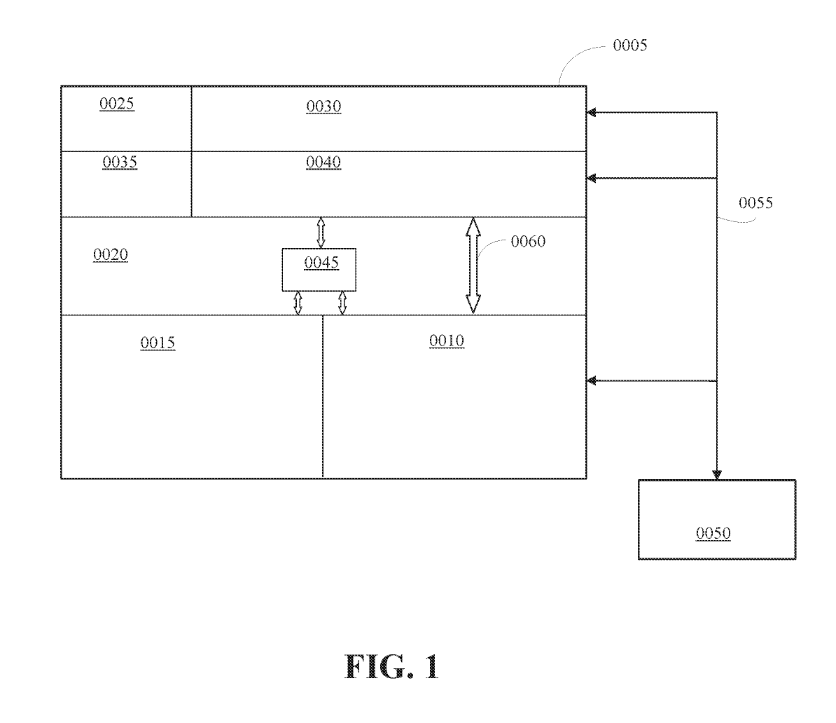

FIG. 1 illustrates a portion of a microprocessor and a processing cluster 0005 configured to execute speculative instructions. Processing cluster 0005 includes processor cores 0010 and 0015. While two processor cores are depicted for illustration purposes more or fewer processor cores may be present in varying embodiments. Processing cluster 0005 includes cache 0020 and lookaside buffer 0045. In other embodiments, more lookaside buffers or no lookaside buffer may be present. Processing cluster 0005 can include cache tags 0025 and 0035 and their associated cache lines 0030 and 0040, respectively. Although cache lines and tags are generally used, and are illustrated in processing cluster 0005, their presence is not a requirement and can vary depending on the embodiment. There can be a plurality of cache lines inside a cache line. The processor cores 0010 and 0015 can be in communication with the cache lines 0030 and 0040 via the connection 0060. In some embodiments, a virtually indexed, physically tagged (VIPT) cache can be used in which the cache is accessed in parallel to a translation lookaside buffer (TLB).

The processor cores 0010 and 0015 can be in communication with a lower level memory 0050 via connection 0055.

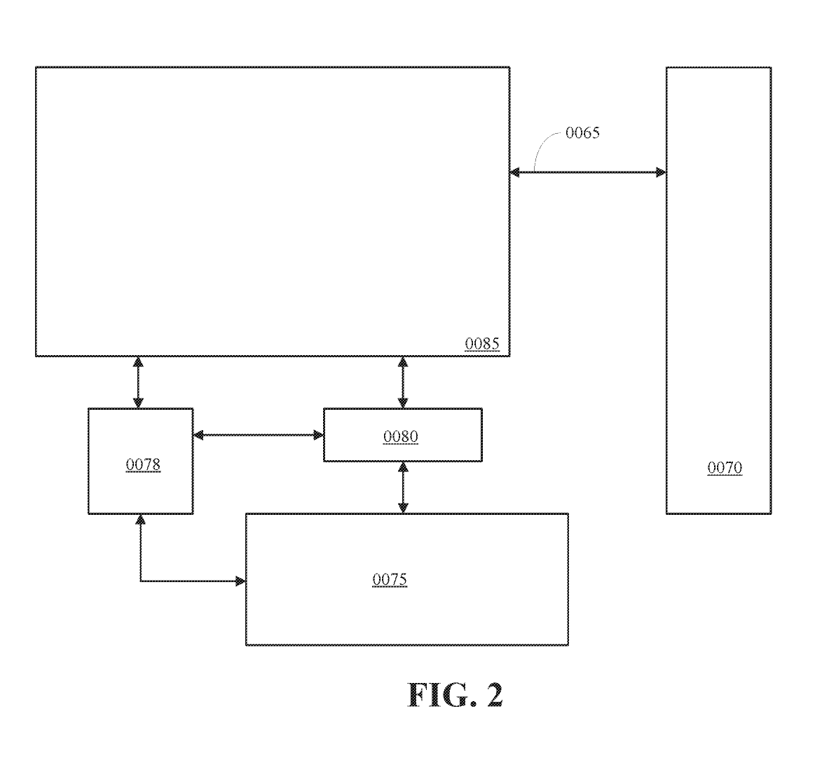

FIG. 2 illustrates a diagram of a portion of a computer system configured to perform speculative operations. Processor core 0075 is in communication with a cache 0085 via a look-aside buffer 0080. Examples of lookaside buffer 080 can include a TLB or a protection lookaside buffer (PLB). The cache 0085 can be in communication with a lower level memory 0070 via connection 0065. While one processor core, one cache and one connection to lower level memory is shown, other processor arrangements including a plurality of these elements are also possible. The processor core 0075 can be configured to perform speculative operations. Examples of the processor core 0075 can include out-or-order CPUs, superscalar CPUs, super-pipelined CPUs, branch predictor CPUs, run-ahead CPUs and CPUs with speculative multithreading.

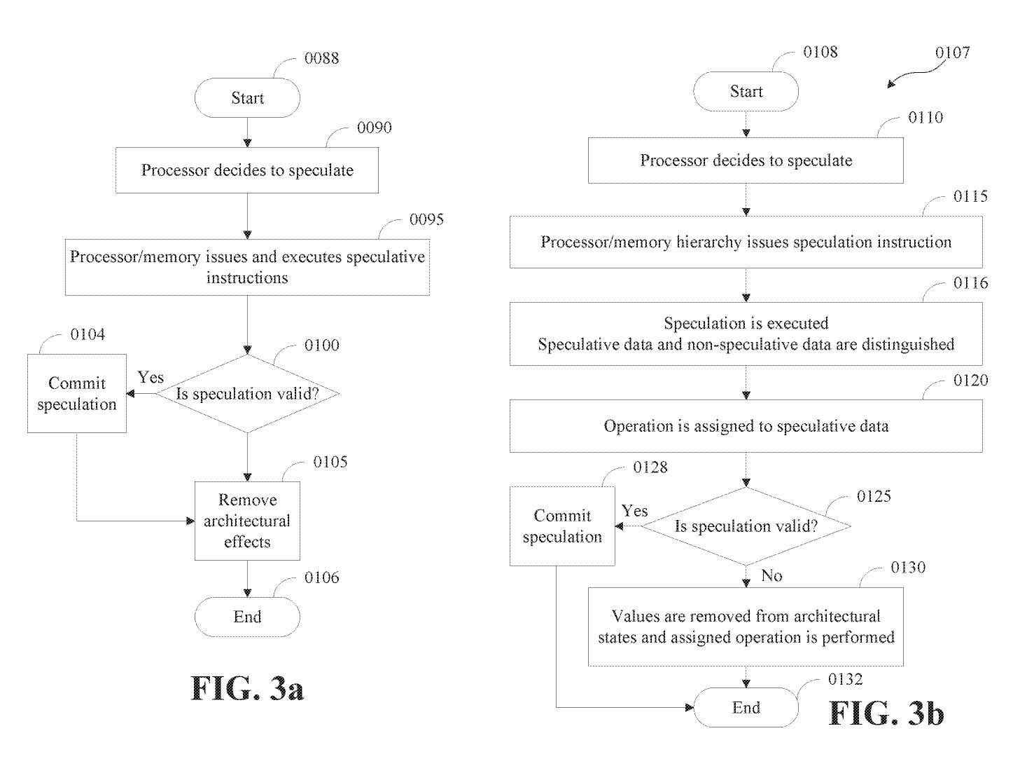

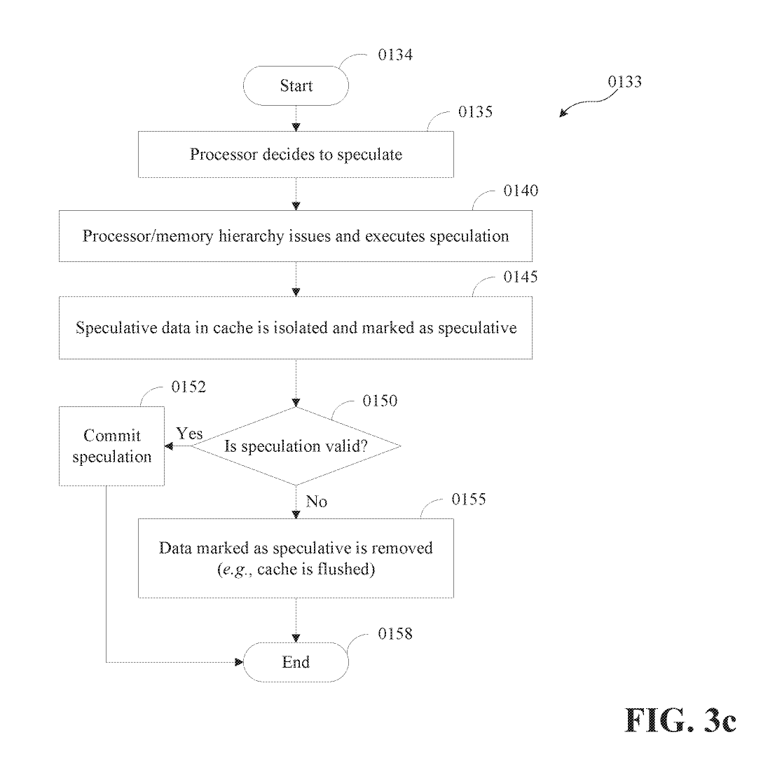

In one embodiment, a decision circuit 0078 may be used to facilitate the implementation and execution of the described embodiments (e.g., the processes of FIGS. 3a-3c). The decision circuit 0078 can be in communication with the cache 0085, lookaside buffer 0080 and the processor core 0075 to distinguish between speculative and non-speculative data. The decision circuit 0078 can be made an integral component of the cache 0085 or a component of the processor core 0075. The decision circuit 0078 can be configured to assign or associate one or more operations with speculative data to maintain the distinction between speculative and non-speculative data. The decision circuit 0078 can scan incoming program instructions and if they operate on speculative data, the decision circuit 0078 can execute one or more operations assigned or associated with the speculative data on the upcoming instructions that are determined to operate on speculative data.

For example, the decision circuit may censor speculative data and the instructions operating on the speculative data from the remainder of the computer system. In some embodiments, the decision circuit can also be configured to choose between two or more assigned operations to speculative data based on the underlying speculation, state of the system and/or trade-offs between performance and risks associated with speculation. For example, the decision circuit 0078 may command removing the speculative data from cache 0085 in some circumstances. In other scenarios, the decision circuit 0078 may only censor the speculative data.

FIG. 3a illustrates a flow chart of a process of speculation which the processor core 075 may employ. The process starts at the step 0088. The process then moves to the step 0090, where the processor core 0075 decides to take a speculative action, for example, speculatively execute an instruction, load/store a value and/or compute a variable. The process then moves to the step 0095, where the processor core 0075 issues the speculative instruction and instruction is performed. The process then moves to the step 0100 where it is determined whether the speculation is valid. If the speculation is valid, the process moves to the step 0104 and the speculative instruction, value and other effects are committed. The process then ends at the step 0106. If at the step 0100, the speculative instruction/data is determined to be invalid, the process moves to the step 0105 where the architectural effects of the speculative instruction of the step 0095 are removed from the computer system. The process then ends at the step 0106.

The speculative instructions of the step 0090 can include a variety of actions that the processor core 0075 may speculatively take. Examples include, load/store instructions, microcode, arithmetic operations (e.g., addition), address generation operations (e.g., bit-shift), complex instruction set computer (CISC), reduced instruction set computer (RISC) and variants of such instructions.

The process of speculation of FIG. 3a can be improved by the speculation processes of FIG. 3b or 3c. FIG. 3b illustrates a flow chart of a process 0107 which the processor 075 can employ to minimize or eliminate side-channel attacks. The process 0107 starts at the step 0108. The process 0107 moves to the step 0110 when the processor decides to execute a speculative instruction and/or compute a speculative value. The process 0107 moves to the step 0115 and the processor and/or memory hierarchy issues the speculative instruction.

Speculative instructions can include a variety of actions that the processor core 0075 may speculatively take. Examples include, load/store instructions, microcode, arithmetic operations (e.g., addition), address generation operations (e.g., bit-shift), complex instruction set computer (CISC), reduced instruction set computer (RISC) and variants of such instructions.

The process 0107 then moves to the step 0116 where the speculative instruction is executed. For example, if a load/store instruction is speculated, the memory hierarchy can move a requested data into a buffer, a register, or cache at a higher-level memory. The process 0107 at the step 0116 makes a distinction between the speculative and non-speculative data. In some embodiments, a lookaside buffer or other buffer can be used to store information pertaining to the speculative nature of data in various levels of memory hierarchy. Example buffers which can be used to store information regarding whether data in memory is speculative or not can include TLBs, PLBs, and synonym lookaside buffer (SLB).

Additionally, in some embodiments, one or more operations are assigned to speculative instructions/data. Such assigned operations are executed on speculative data/instructions simultaneously, in addition to and/or in combination with other program instructions the processor core may be executing. The assigned operations in effect enable the processor core 0075 to treat the speculative instructions/data differently than non-speculative instruction/data and maintain one or more distinguishing features between speculative instruction/data (and any resulting data from the speculative data) and non-speculative data. Assigned operations for speculative data to result in different behavior and treatment of speculative data can enable various strategies to prevent or minimize side-channel attacks.

For example, in one embodiment, an assigned operation to speculative instruction/data may be to censor the speculative instruction/data until the speculative instruction/data is committed. Censoring can include sub-operations such as marking, isolating, hiding, and restricting access before a speculation is committed.

In some scenarios, speculative data is the subject of operational requests, such as load/store, before the speculative data is committed. Censoring can include censoring all speculative data and non-architectural effects resulting from a speculative instruction/data due to other operational requests performed on the speculative data. For example, if a variable var is speculative, and is used in subsequent operations such as load/store and/or arithmetic operations, then var and resulting data/instructions can be censored. For example, the cache region in which var and/or speculative data/instructions based on var are stored can be censored from the rest of the system.

Next the process 0107 moves to the step 0125 where it is determined whether the speculation is valid. If the speculation is valid, the process 0107 moves to the step 0128 where the speculative instruction/data and resulting data are committed. The process 0107 then ends at the step 0132. If the speculation is determined to be invalid, the process 0107 moves to the step 0130 where various actions can be taken to prevent or minimize risk of side-channel attacks. For example, speculative values can be removed from architectural states and one or more assigned operations can be performed. In one embodiment, if the assigned operation is a censoring operation, the speculative data can remain censored until they are overwritten thereby preventing or minimizing risk of side-channel attacks from non-committed invalid speculative data. In another embodiment, once the speculative data is determined to be incorrect, both architectural and non-architectural effects of speculative data can be removed. For example, CPU registers, buffers, and cache regions and/or other memory holding speculative data can be removed (e.g., by flushing a cache word and/or line). The process 0107 then ends at the step 0132.

FIG. 3c illustrates a flow chart of a process 0133 which can be used to prevent or minimize side-channel attacks. The process 0133 starts at the step 0134 and moves to the step 0135 where the processor decides to execute a speculative instruction and/or compute a speculative value. The process 0133 moves to the step 0140 where the processor 075 and/or memory hierarchy issues and executes the speculative instruction. The process then moves to the step 0145 where speculative instruction/data is marked. In one embodiment, marking the speculative data includes storing information mapping a speculative value to its originating speculative instruction. A lookaside buffer or other buffer can be used to store marking and/or mapping information pertaining to the speculative nature of data in various levels of memory hierarchy. Example buffers which can be used to store marking and/or mapping information regarding whether data in memory is speculative or not can include TLBs, PLBs, and synonym lookaside buffer (SLB).

In one embodiment, an isolating operation is assigned to the speculative data, for example by restricting access to the rest of memory hierarchy and/or other physical/non-physical parts of the computer system.

The process 0133 then moves to the step 0150 where it is determined whether the speculation is valid. If the speculation is valid, the process 0133 moves to the step 0152 where the speculation and resulting data are committed. The process 0133 then ends at the step 0158. If the speculation is invalid, the process 0133 moves to the step 0155 where one or more actions can be taken to eliminate or minimize the risk of side-channel attacks. For example, in one embodiment, all marked speculative data can be removed (e.g., by flushing cache regions marked as holding speculative data). In another embodiment, incorrect speculative data can be removed from both architectural and non-architectural states using the marking and/or the mapping. The process 0133 then ends at the step 0158.

While the embodiments are described and illustrated in terms of processes, a computer system, a CPU, a cache or a computer system memory hierarchy can be designed and configured in hardware and/or software to implement the processes described in order to eliminate or minimize the risk of side-channel attacks. For example, in some embodiments, a decision circuit can be used to operate on cache or memory to perform one or more of the steps outlined in the processes of FIGS. 3a-3c.

Techniques to Store Information Pertaining to Speculative Nature of Data

Information on whether a memory location address holds speculative data can be stored as a bit per word or as a bitmask containing a number of elements at least equivalent to the number of words in the associated region of the bitmask. In one embodiment, information pertaining to whether a memory address (e.g., a cache word) holds speculative data can be stored as a bit per word and information pertaining to the speculation event originating the speculative data can be stored at a granularity of buffer, register or cache line and/or buffer, register or cache region. In one embodiment, information pertaining to whether a value is speculative can be stored in an information piece at least one bit in length. In one embodiment, information pertaining to the speculative event originating a speculative value can be stored in an information piece at least one bit in length.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first, second, other and another and the like may be used solely to distinguish one entity or action from another without necessarily requiring or implying any actual such relationship or order between such entities or actions.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A method of speculation in a microprocessor, comprising:
deciding whether to perform speculation;
issuing and executing a speculation event;
generating speculative data, wherein speculative data comprises instructions and/or data based on the speculation event;
receiving and executing non-speculative instructions;
generating non-speculative data based on non-speculative instructions;
distinguishing between the speculative and non-speculative data and their respective underlying effects;
assigning one or more operations to the speculative data and/or instructions; and
performing the one or more assigned operations on the speculative data and/or instructions.

2. The method of claim 1 further comprising:
determining whether the speculation event is valid;
committing the speculation event and the speculative data if the speculation event is valid; and
removing architectural and non-architectural effects of the speculation event if the speculation event is invalid.

3. The method of claim 2, wherein removing non-architectural effects comprises flushing a region of a cache.

4. The method of claim 1, wherein the assigned one or more operations comprise one or more of marking the speculative data and censoring the marked speculative data until the data is committed or is overwritten.

5. The method of claim 1 further comprising storing information on the speculation event and resulting speculative data.

6. The method of claim 5, further comprising issuing and executing a plurality of speculation events and wherein storing information further comprises storing information mapping speculation events to their respective speculative data.

7. The method of claim 5, wherein storing information comprises storing bit per word, or a bitmask comprising a number of bits at least equivalent to number of words where speculative data is held.

8. The method of claim 1 further comprising: loading a program instruction and performing at least one of the one or more assigned operations if the program instruction relies on the speculative data.

9. A processor configured to perform the method of claim 1.

10. A processor optimized for performing speculation, the processor comprising:
a processor core configured to issue and execute instructions generating speculative and non-speculative data;
a memory configured to store information to distinguish between speculative and non-speculative data;
a decision circuit configured to perform one or more operations on the speculative data.

11. The processor of claim 10, further comprising caches, buffers and registers configured to track speculative data.

12. The processor of claim 10, wherein the one or more operations comprise one or more of marking, censoring, isolating and/or removing the speculative data.

13. The processor of claim 10 wherein the stored information further comprises a mapping of speculative data to a speculative instruction.

14. The processor of claim 10, wherein the memory configured to store information comprises a lookaside buffer.

15. The processor of claim 10, wherein the decision circuit is further configured to perform at least one of the one or more operations when an operational request such as load/store is cast upon a speculative data.

16. The processor of claim 10 further comprising an overflow memory configured to receive and store overflow speculative data.

17. The processor of claim 10, wherein the decision circuit is configured to remove non-architectural effects of the speculative data when the speculative data is determined to be invalid.

18. The processor of claim 17, further comprising a second memory where speculative data is stored and the memory configured to store information is further configured to store memory addresses in the second memory where speculative data is stored and wherein removing non-architectural effects comprises removing speculative data from the second memory.

19. The processor of claim 18, wherein the second memory comprises a cache and/or buffer of the processor.

20. The processor of claim 10, wherein the processor core is configured to decide whether or not to perform speculation.
